(19) United States
(12) Patent Application Publication
(10) Pub. No.: US 2010/0182271 A1
(43) Pub. Date: Jul. 22, 2010

(54) METHOD FOR ACHIEVING A DECORATIVE BACKLIT SENSING PANEL WITH COMPLEX CURVATURE

(76) Inventor: James Frederick Krier, Grosse Pointe Woods, MI (US)

Correspondence Address: FRASER CLEMENS MARTIN & MILLER LLC, 28366 KENSINGTON LANE, PERRYSBURG, OH, 43551, US

(21) Appl. No.: 12/357,214

(22) Filed: Jan. 21, 2009

(51) Int. Cl. G06F 3/044

(52) U.S. Cl. 345/174; 178/18.06; 977/742; 977/952

(57) ABSTRACT

A conductive panel includes a film layer formed to a pre-determined shape having a complex curvature, a conductive array having a plurality of electrical traces insulated from one another by a dielectric material, the conductive array disposed adjacent the film layer, and a substrate disposed adjacent at least one of the film layer and the conductive array for supporting the conductive panel.

### FIELD OF THE INVENTION

The invention relates to display control panels. More particularly, the invention is directed to a conductive panel and method for forming a conductive panel having a multiple axis, multiple dimension surface curvature.

### BACKGROUND OF THE INVENTION

Automotive display control panel technology is moving from traditional non-interactive displays and mechanical switches to touch-sensitive screens and electronic sensing switches. Due to sensor materials and assembly limitations, current art is constrained to simple geometry (flat or curvature in one direction). Simple geometry is not compatible with automotive industrial design and performance expectations which desire multi-axial complex curvature surfaces and optically acceptable display lenses with backlighting characteristics.

Current art includes discrete electrically conductive materials (carbon, metallic & metal oxides) and dielectric materials (polymers) that are deposited on various media including clear films. Currently, films are formed from metallic oxides which have limitations on the amount of strain that the material can withstand. Such films are limited in an ability to be adhered in a flat form to compound curvature surfaces without showing optical defects, especially in applications such as three dimensional touch screen lenses.

Additionally, electrical interconnection methods for three dimensional decorative displays and control panel applications typically require multiple discrete planar elements (e.g. circuit boards and connectors) or flex circuits that do not conform to the complex curvature of the decorative display or control panel.

It would be desirable to develop a conductive panel and method for forming a conductive panel, wherein the conductive panel and method provide a touch-sensitive panel having a complex shape and contour with a multi-axial curvature.

### SUMMARY OF THE INVENTION

Concordant and consistent with the present invention, a conductive panel and method for forming a conductive panel, wherein the conductive panel and method provide a touch-sensitive panel having a complex shape and contour with a multi-axial curvature, has surprisingly been discovered.

In one embodiment, a conductive panel comprises: a film layer formed to a pre-determined shape having a multiple axis, multiple dimension surface curvature; a conductive array having a plurality of electrical traces insulated from one another by a dielectric material, the conductive array disposed adjacent the film layer; and a substrate disposed adjacent at least one of the film layer and the conductive array for supporting the conductive panel.

In another embodiment, a conductive panel system comprises: a film layer formed to a pre-determined shape; a conductive array having a plurality of electrical traces insulated from one another by a dielectric material, the conductive array disposed adjacent the film layer; and a substrate disposed adjacent at least one of the film layer and the conductive array for supporting the conductive panel, wherein the substrate is formed to receive an electrical interconnection device for providing electrical communication between the conductive array and a secondary device.

The invention also provides methods for forming a conductive panel.

One method comprises the steps of: forming a film layer into a desired shape; depositing a conductive array on a surface of the film layer, wherein the conductive array includes a plurality of electrically conductive traces insulated from one another by a dielectric material; and providing a substrate adjacent at least one of the film layer and the conductive array to provide rigid support for the film layer.

### BRIEF DESCRIPTION OF THE DRAWINGS

The above, as well as other advantages of the present invention, will become readily apparent to those skilled in the art from the following detailed description of the preferred embodiment when considered in the light of the accompanying drawings in which:

FIG. 1 is a perspective view of a conductive panel according to an embodiment of the present invention;

FIG. 2 is a top elevational view of the conductive panel of FIG. 1;

FIG. 3 is a side elevational view of the conductive panel of FIG. 1;

FIG. 4 is a front elevational view of the conductive panel of FIG. 1;

FIG. 5 is a fragmentary cross sectional view of the conductive panel of FIG. 4 taken along line 5-5 of FIG.4;

FIG. 6 is a fragmentary cross sectional view of a conductive panel according to another embodiment of the present invention;

FIG. 7 is a fragmentary cross sectional view of a conductive panel according to another embodiment of the present invention taken along line 7-7 of FIG. 4;

FIG. 8 is a fragmentary cross sectional view of a conductive panel according to another embodiment of the present invention;

FIG. 9 is a fragmentary cross sectional view of a conductive panel according to another embodiment of the present invention;

FIG. 10 is a fragmentary cross sectional view of a conductive panel system including a conductive panel according to another embodiment of the present invention; and

FIG. 11 is a cross sectional view of the conductive panel of FIG. 10 according to another embodiment of the present invention, wherein the conductive panel is coupled to a flex circuit.

### DETAILED DESCRIPTION OF EXEMPLARY EMBODIMENTS OF THE INVENTION

The following detailed description and appended drawings describe and illustrate various embodiments of the invention. The description and drawings serve to enable one skilled in the art to make and use the invention, and are not intended to limit the scope of the invention in any manner. In respect of the methods disclosed, the steps presented are exemplary in nature, and thus, the order of the steps is not necessary or critical.

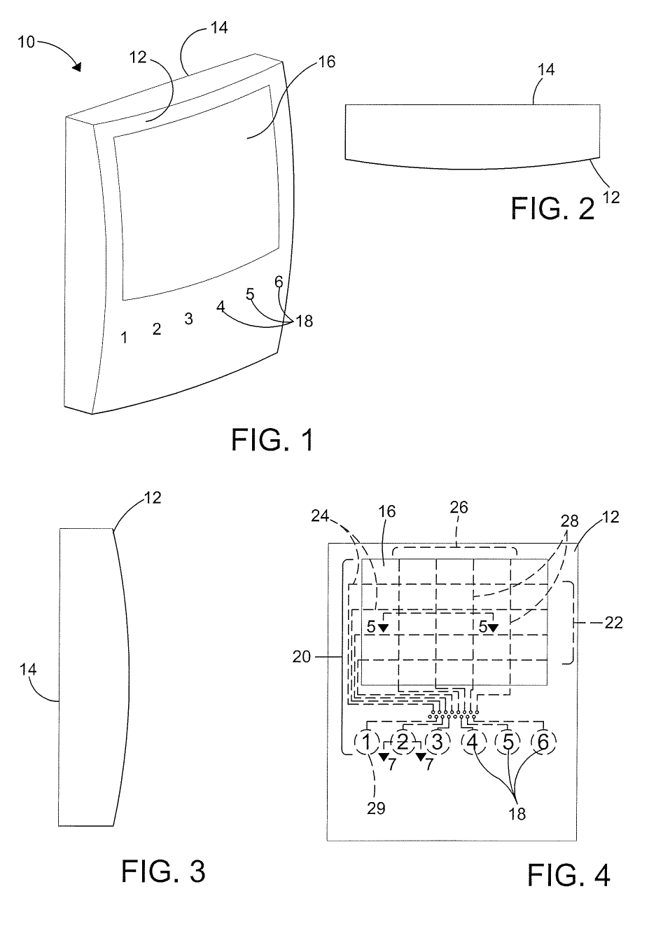

FIGS. 1-4 illustrate a conductive panel 10 according to an embodiment of the present invention. For example, the conductive panel 10 is a backlit touch-sensitive panel having decorative features. As another example, the conductive panel 10 may be an electroluminescent (EL) lamp panel or a stripline antenna panel. The conductive panel 10 has a curved first surface 12 with a multi-axial convex contour and a second surface 14. However, the conductive panel 10 may have any shape, curvature, form, and size including a complex curvature, wherein a complex curvature includes a multiple axis, multiple dimension surface curvature such as a dome shape, for example.

The conductive panel 10 includes a display window 16 and a plurality of legends 18 formed therein. The display window 16 is an optical lens providing a means for viewing a back lit display device (not shown) disposed adjacent the second surface 14 of the conductive panel 10. A conductive array 20 is disposed adjacent the display window 16 and each of the legends 18 to provide a capacitive sensing function to the display window 16 and the legends 18. As shown, the conductive array 20 includes an X-trace layer 22 having a plurality of first parallel conductive traces 24 and a Y-trace layer 26 having a plurality of second parallel conductive traces 28. Additionally, the conductive array 20 includes a plurality of discrete sensor pads 29 associated with each of the legends 18 to provide a capacitive sensing function to the legends 18. It is understood that any means for providing a sensing function may be used such as measuring a change in capacitance of the conductive array 20, for example. It is further understood that, the conductive traces 24, 28 may have substantial resistance, which permits a variety of materials and processes to be used for fabrication.

As a non-limiting example, for applications where the conductive materials can be opaque (i.e. not directly in the lighting path of backlit elements), the conductive array 20 may be formed from at least one of conductive carbon inks, metal particle inks (e.g. silver), and copper plated traces (additively or subtractively applied).

For translucent or substantially transparent applications, the conductive array 20 may be formed from metal oxides such as InSnO₂, conductive polymers such as poly(3,4-ethylenedioxythiophene)(PEDOT), carbon nanotube wherein conductive carbon nanotubes are dispersed in a liquid material for deposition and an evaporation of the liquid material results in a conductive transparent film, silver dispersions where finely dispersed nanosilver particles in an emulsion are coated on a surface and careful evaporation results in a uniform coating density that provides a transparent conductive film, and very fine deposited copper where extremely thin copper wires are additively or subtractively applied to a surface.

In addition to traditional processes, a roll to roll system having combined inkjet and plating systems can be used to deposit very thin conductive traces lines that are barely discernable to the human eye to simulate transparency for display touchscreens. A similar process is currently used by Conductive Inkjet Technologies, http://www.conductiveinkjet.com, a subsidiary of Carlco Plc.

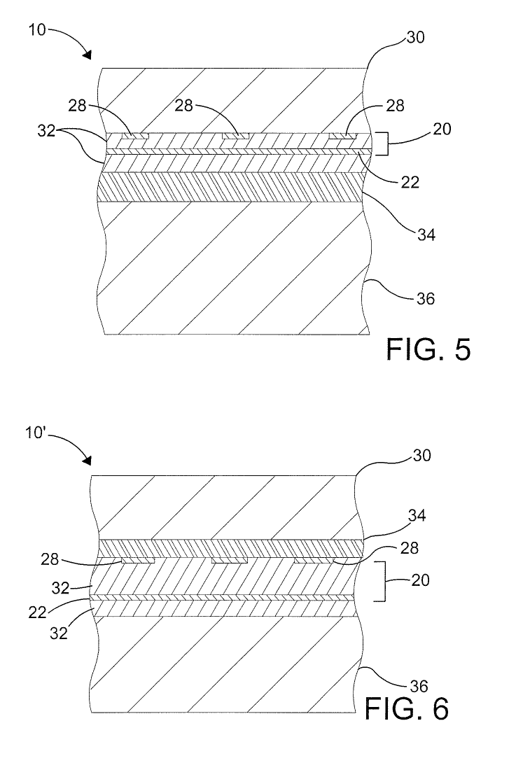

As more clearly shown in FIG. 5, the conductive panel 10 further includes a film layer 30, a dielectric material 32, a decorative layer 34, and a substrate 36. As shown, the decorative layer 34 is disposed on the substrate 36. However, it is understood that filtering may be achieved through the use of pigments and dyes included within the film 30 to minimize or eliminate the processing complexity of the decorative layer 34. The dielectric material 32 is interposed with the conductive array 20 to insulate the X-trace layer 22 from the Y-trace layer 26. Additionally, the dielectric material 32 may be interposed to isolate the conductive array 20 from adjacent layers. The conductive array 20 including the interposed dielectric material 32 is disposed on the decorative layer 34 and the film layer 30 is disposed on the conductive array 20 to form the multi-layered conductive panel 10.

The film layer 30 provides a formable surface to be shaped into a suitable contour design. The film layer 30 may have any shape, curvature, form, and size including a complex curvature having a multiple axis, multiple dimension surface curvature such as a dome shape, for example. The film layer 30 is typically formed from a substantially transparent PET (polyester) or PC (polycarbonate). However other plastics and resins such as PEN (Polyethylene) and PES (Polyethersulfone) may be used. It is understood that the film layer 30 may also be formed from a material suitable for oxygen and moisture resistance, low coefficient of thermal expansion, high temperature resistance for processing, and birefringence, for example.

The dielectric material 32 is interposed between at least one of the substrate 36 and the conductive array 20, the conductive array 20 and the decorative layer 34, and the film layer 30 and the conductive array 20 to provide an insulator therebetween. As a non-limiting example, the dielectric material 32 is a dielectric ink. It is understood that dielectric inks are polymeric based using a solvent that is either cured via evaporation or through ultra-violet photoinitiation.

The dielectric material 32 layer may also include a barrier material. It is understood that barrier materials serve to limit the migration rate of oxygen and moisture that can degrade performance. For example, certain sensitive electronic materials such as organic light emitting diodes (OLED) and electroluminescent (EL) phosphors require improved barrier protection against oxygen and water vapor. Accordingly, the dielectric material 32 may include glass, which is substantially impermeable to oxygen and water vapor. As a further non-limiting example, the dielectric material 32 may include a single layer gas barrier film such as inorganic SiOx, AlOx materials deposited onto a polymer film substrate and multilayer gas barrier films. Specifically, multiple layers of inorganic AlOx and organic (acrylate) polymers are used to improve on the limited performance of single layer films caused by microscopic defects of the coating.

The decorative layer 34 typically includes inks for opaque, translucent, and filtered transparent applications. The decorative inks require material properties to enable them to withstand the In-Mold process and withstand forming strains without showing light leaks and appearance degradation. The actual performance is dependent on whether the application is front or back surface printing, specifically with back surface printing, due to the injection molded resin making contact with the inks under heat and pressure. Decorative inks are typically polyester or polycarbonate based that can withstand the high temperatures and pressures of the molding process without washing out.

The substrate 36 is typically formed from Resins for transparent and/or backlit applications, the plastic resin must have adequate transparency, PC and PMMA (acrylic) are typical workhorse materials that are currently used in In-Mold decorating processes.

In use, the conductive array 20 and dielectric material 32 coatings are applied to the film layer 30. The film layer 30 is formed to a pre-determined shape having a suitable contour and curvature. Additionally, the decorative layer 34 may be applied to meet the appearance intent, including opaque colors, display lens filters, legends, and backlit diffusing coatings. The substantially clear substrate 36 is then applied behind the formed film layer 30 to provide structure and other panel-related functional features required for the conductive panel 10. Deposition of the conductive array 20 and dielectric material 32 may occur prior to forming the film layer 30 or after forming, depending on the technology used for the conductive array 20 and dielectric material 32 properties. It is understood that various forming process may be used to shape the film layer 30 such as thermoforming described in U.S. Pat. Nos. 2,365,637, 2,377,946, and 2,368,697, high pressure forming described in U.S. Pat. Nos. 5,217,563 and 6,257,866, hydroforming as described in U.S. Pat. No. 2,348,921 and In-Mold decorating processes described in U.S. Pat. No. 3,122,598, each of which is hereby incorporated herein by reference in its entirety. It is understood that other forming processes and methods may used such as cold embossing and variation of thermoforming, high pressure forming, hydroforming, and in-mold forming, for example.

Once formed into the desired contour and shape, the conductive panel 10 provides a sensing function to a user on a curved surface. Specifically, the conductive traces 24, 28 are electrically insulated from one another by the dielectric material 32. Mutual capacitance exists between each of the conductive traces 24, 28, and stray capacitance exists between each of the conductive traces 24, 28 and a ground. A finger positioned in proximity to the conductive array 20 alters the mutual and stray capacitance values of the conductive traces 24, 28. The degree of alteration depends on the position of the finger with respect to the conductive traces 24, 28. In certain embodiments the conductive array 20 may be adapted to cooperate with an electroluminescent (EL) phosphor layer to provide a lighting function. In other embodiments, the conductive array 20 may be adapted to function as a stripline antenna.

FIG. 6 illustrates a cross sectional view of a conductive panel 10′ according to an alternative embodiment of the present invention similar to the conductive panel 10 of FIGS. 1 through 5, except as described below. Structure repeated from the description of FIGS. 1 through 5 includes the same reference numeral. As shown, the conductive panel 10′ includes the decorative layer 34 disposed adjacent the film layer 30 so that the decorative layer 34 is between the film layer 30 and the conductive array 20. It is understood that a filtering may be achieved through the use of pigments and dyes included within the film layer 30 to minimize or eliminate the processing complexity of the decorative layer 34. Additionally, the dielectric material 32 is disposed between the conductive array 20 and the substrate 36 for suitable insulation.

In use, the conductive array 20, the dielectric material 32 coatings and decorative layer 34 are applied to the film layer 30. The film layer 30 is formed to a pre-determined shape having a suitable contour and curvature. The substantially clear substrate 36 is then applied behind the formed film layer 30 to provide structure and other panel-related functional features required for the conductive panel 10′. Deposition of the conductive array 20 and the dielectric material 32, and the decorative layer 34 may occur prior to forming the film layer 30 or after forming, depending on the technology used for the conductive array 20, the dielectric material 32 properties and the decorative layer.

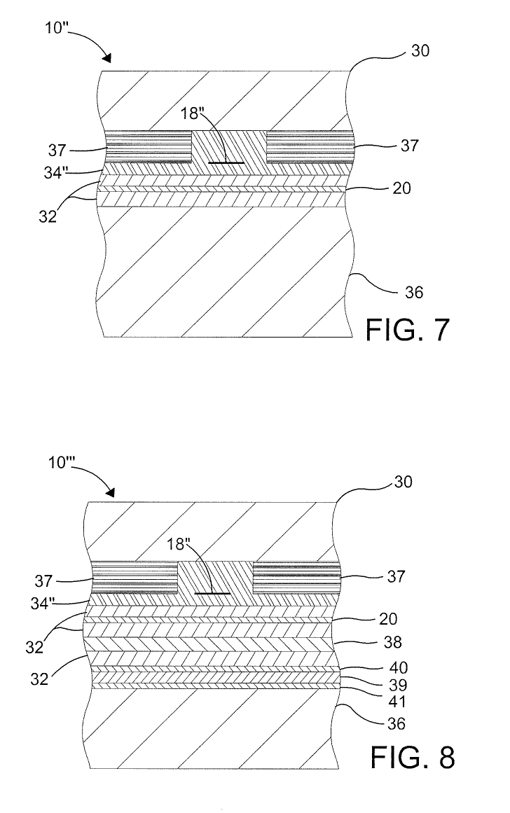

FIG. 7 illustrates a cross sectional view of a conductive panel 10″ taken along line 7-7 of FIG. 4 according to another embodiment of the present invention similar to the conductive panel 10 of FIGS. 1 through 5, except as described below. Structure repeated from the description of FIGS. 1 through 5 includes the same reference numeral. Variations of structure shown in FIGS. 1 through 5 include the same reference numeral and a double prime (″) symbol.

The conductive panel 10″ includes a decorative layer 34″ having an opaque filter coating 37. As shown, the decorative layer 34″ is disposed adjacent the film layer 30, such that the decorative layer 34″ is interposed between the conductive array 20 and the film layer 30.

In use, the opaque filter coating 37 substantially blocks light emitted from the backlit device from escaping through the film layer 30. As shown, a portion of the decorative layer 34″ is formed to allow light to pass through the decorative layer 34″ and into the film layer 30. As a non-limiting example, light may be permitted to illuminate a graphical legend 18″ formed in the decorative layer 34″ while blocking light outside the legend 18″.

FIG. 8 illustrates a cross sectional view of a conductive panel 10′″ according to an alternative embodiment of the present invention similar to the conductive panel 10″ of FIG. 7, except as described below. Structure repeated from the description of FIG. 7 includes the same reference numeral.

As shown, the conductive panel 10′″ includes a grounding layer 38 in electrical communication with the conductive array 20 to minimize sensitivity to electrical noise. Additionally, an electroluminescent (EL) layer 39 is disposed between a first electrode 40 and a second electrode 41 to provide to provide an EL lamp application, as is known in the art. It is understood that any EL lamp device and structure may be included such as the lamps described in U.S. Pat. Nos. 5,051,654 and 5,811,930, each of which is hereby incorporated herein by reference in its entirety. In the embodiment shown, the first electrode 40 is spaced from the grounding layer 38 and the dielectric material 32 is disposed therebetween. It is understood that other arrangements of the dielectric material 32, grounding layer 38 and EL layer 39 may be used. The EL layer 39 may be formed from an electroluminescent material such as electroluminescent phosphors which cooperate with the electrical functions of the electrodes 40, 41 to provide the EL lamp application. The first electrode 40 is typical formed from a substantially transparent conductive material similar to conductive layer 20 (e.g. PEDOT). The second electrode 41 is typical formed from a printed conductive metal such as metal nanotubes and dispersed silver particles, for example.

In use, the conductive array 20, the dielectric material 32 coatings, and the grounding layer 38 are applied to the film layer 30. The film layer 30 is formed to a pre-determined shape having a suitable contour and curvature. Additionally, the decorative layer 34″ may be applied to meet the appearance intent, including opaque colors, display lens filters, legends, and backlit diffusing coatings. The EL layer 39, sandwiched between the electrodes 40, 41, is applied to the formed film layer 30 to add the EL lamp functionality. Finally, a substantially clear substrate 36 is then applied behind the formed film layer 30 to provide structure and other panel-related functional features required for the conductive panel 10′″. Deposition of the conductive array 20 and the dielectric material 32, the grounding layer 38, and the EL layer 39 may occur prior to forming the film layer 30 or after forming, depending on the technology used for the conductive array 20, the dielectric material 32 properties, the material used for the grounding layer 38, and the EL layer 39. Once formed, the electrodes 40, 41 are in electrical communication with the EL layer 39 to provide an electrical current to the EL layer 39 for generating and emitting light from the conductive panel 10′″.

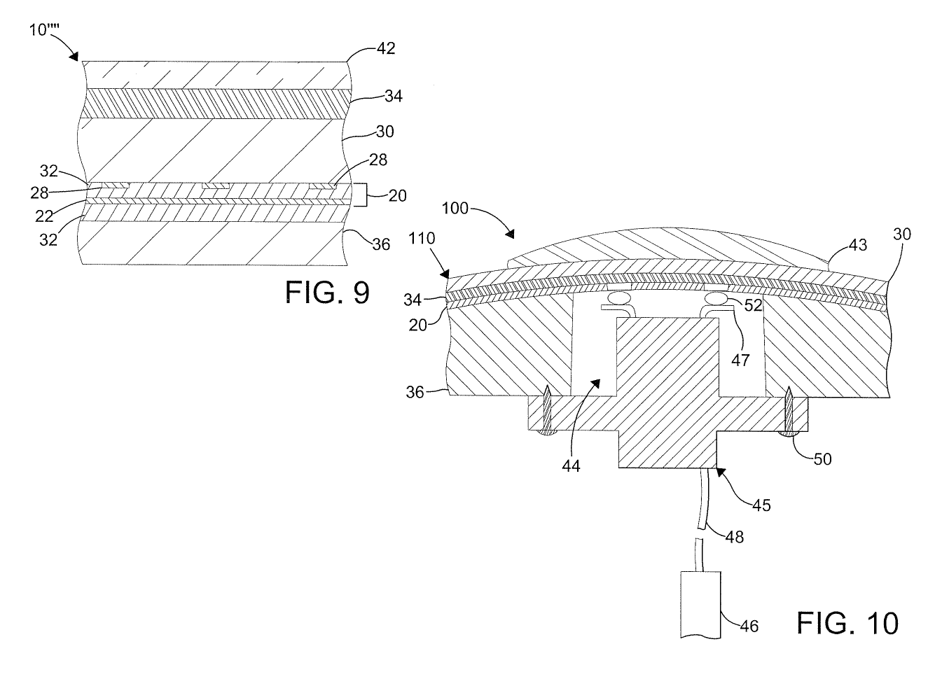

FIG. 9 illustrates a cross sectional view of a conductive panel 10″″ according to an embodiment of the present invention similar to the conductive panel 10 of FIGS. 1 through 5, except as described below. Structure repeated from the description of FIGS. 1 through 5 includes the same reference numeral. Variations of structure shown in FIGS. 1 through 5 include the same reference numeral and a quadruple prime (″″) symbol.

As shown, the decorative layer 34 is disposed on the film layer 30, such that the film layer 30 is interposed between the decorative layer 34 and the conductive array 20. Additionally, a protective layer 42 is disposed on the decorative layer 34 to provide a surface barrier to minimize damage to the underlying layers.

In use, the conductive array 20 and dielectric material 32 coatings are applied to the film layer 30. The film layer 30 is formed to a pre-determined shape having a suitable contour and curvature. Additionally, the decorative layer 34 is disposed on the film layer 30 to meet the appearance intent, including opaque colors, display lens filters, legends, and backlit diffusing coatings. The substantially clear substrate 36 is then applied behind the formed film layer 30 to provide structure and other panel-related functional features required for the conductive panel 10″″. Deposition of the conductive array 20, dielectric material 32, and decorative layer 34 may occur prior to forming the film layer 30 or after forming, depending on the technology used for the conductive array 20 and dielectric material 32 properties. The placement of the decorative layer 34 on the film layer 30 provides a means to hide the conductive array 20 and other electronic layers by the filters and coatings included in the decorative layer 34. Additionally, the manufacturing process may be divided into separate stages including an electronic manufacturing stage, wherein the conductive array 20 is applied to the film layer 30 and a decorative stage, wherein the decorative layer 34 is applied to the film layer 30, thereby providing efficient manufacturing logistics.

FIG. 10 illustrates a cross sectional view of a conductive panel system 100 according to an embodiment of the present invention. As shown, the conductive panel system 100 includes a conductive panel 110 similar to the conductive panel 10 of FIGS. 1 through 5, except as described below. Structure repeated from the description of FIGS. 1 through 5 includes the same reference numeral.

As shown, the conductive panel 110 includes a trim element 43 disposed on the film layer 30 to mask aesthetic inconsistency caused by an aperture 44 formed in the substrate 36. Additionally, the trim element 43 provides structural support to the conductive panel 110. Alternatively, the aperture 44 may be located in a non-aesthetic location of the conductive panel 110 to eliminate the need for trim element 43. The aperture 44 is adapted to receive an electrical interconnection device 45 to provide electrical communication between the conductive panel 110 and a secondary device 46 such as a source of electrical energy, a capacitance measurement device, and a processor, for example.

The electrical interconnection device 45 includes a plurality of electrical leads 47, an electrical cable 48, and an attachment means 50. As a non-limiting example, the electrical interconnection device 45 is a conventional electrical connector. As a further example, the electrical interconnection device 45 is a flex circuit. Other interconnection devices for providing electrical intercommunication may be used.

The electrical leads 47 are coupled to a portion of the conductive array 20 to provide electrical communication between the conductive array 20 and the secondary device 46. An electrically conductive epoxy 52 is applied between the electrical leads 47 and the conductive array 20. As a non-limiting example, the conductive epoxy 52 may be a low temperature curing epoxy. As a further example, conductive epoxy may be EP-600 silver filled epoxy adhesive as manufactured by Conductive Compounds. Other electrically conductive epoxy materials may be used.

The electrical cable 48 is in electrical communication with the electrical interconnection device 45 and the secondary device 46. The electrical cable 48 may be any device, wire, or electrical conduit for transmitting electrical current such as a ribbon cable, for example.

The attachment means 50 selectively couples the electrical interconnection device 45 to the substrate 36, while providing an alignment function and strain relief function on the epoxy 52 connection between the leads 47 and the conductive array 20. The attachment means 50 may be any feature or device for aligning and coupling the electrical interconnection device 45 to the substrate 36 of the conductive panel 110 such as staking pins, screws, and retention clips, for example.

In use, the electrical interconnection device 45 provides a means for electrical communication between the conductive array 20 and the secondary device 46 that is compatible with various designs and curvatures of the conductive panel 110. The attachment means 50, along with the conductive epoxy 52, securely couples the electrical interconnection device 45 with the substrate 36 while aligning the leads 47 of the electrical interconnection device 45 with an appropriate portion of the conductive array 20.

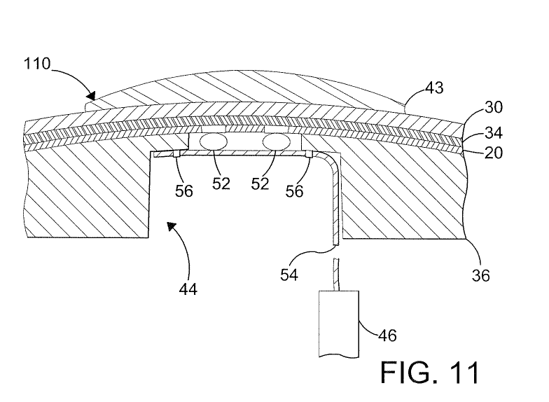

FIG. 11 shows the conductive panel 110 of FIG. 10 coupled to a flex circuit 54 according to another embodiment of the present invention. Structure repeated from the description of FIG. 10 includes the same reference numeral. As shown the flex circuit 54 is coupled to the substrate 36 of the conductive panel 110 by a plurality of retention features 56. It is understood that any means for aligning and coupling the flex circuit 54 to the substrate 36 may be used such as clips, for example.

In use, the flex circuit 54 provides a means for electrical communication between the conductive array 20 and the secondary device 46 that is compatible with various designs and curvatures of the conductive panel 110. The retention features 56 along with the conductive epoxy 52 securely couple the flex circuit 54 with the substrate 36 while aligning the flex circuit 54 with an appropriate portion of the conductive array 20.

The conductive panel 10, 10′, 10″, 10′″, 10″″, 110 effectively integrates decorative appearance and electronic processing to produce a backlit-capable display with electronic functions such as capacitive sensing, integral EL lighting, and stripline antennas. The use of various forming processes comprising heat and pressure capable of applying multi-axial strain to the film layer 30, provide for the generation of variable geometry, ranging from planar and simple single axis to complex curvature and contour designs. Compensation of electronic performance changes (e.g. capacitance) that occur during and after the forming process are achieved by at least one of material deposition adjustments such as modifying artwork line width and depth of the conductive traces 24, 28 in selective areas and measurement of property changes after forming for capacitance calibration calculations and subsequent modifications.

The integration of decorative and sensing technologies with the film layer 30 eliminates an optical interface between the decorative and electronic sensor features. Current art for discreet treatment of the decorative and electronic sensor functions is achieved via addition of an optical adhesive layer including inherent optical losses such as haze, transmission, and color shift or an air interface, which minimizes transmission and maximizes internal reflections.

Integration of decorative and sensing technologies with the film layer 30 also improves sensing performance by reducing the dielectric distance the conductive array 20 is from the front of the conductive panel 10′, 10″, 10′″, 10″″, 110 compared to current art that requires a relatively thick panel in front of the sensing array for structural and manufacturing reasons.

From the foregoing description, one ordinarily skilled in the art can easily ascertain the essential characteristics of this invention and, without departing from the spirit and scope thereof, make various changes and modifications to the invention to adapt it to various usages and conditions.

What is claimed is:

1. A conductive panel comprising:
a film layer formed to a pre-determined shape having a multiple axis, multiple dimension surface curvature;
a conductive array having a plurality of electrical traces insulated from one another by a dielectric material, the conductive array disposed adjacent the film layer; and
a substrate disposed adjacent at least one of the film layer and the conductive array for supporting the conductive panel.

2. The conductive panel according to claim 1, wherein at least one of the substrate, the conductive array, and the film layer is substantially transparent.

3. The conductive panel according to claim 1, wherein the film layer is formed from at least one of a polyester, a polycarbonate, a polyethylene, a polyethersulfone, and a plastic resin.

4. The conductive panel according to claim 1, wherein the conductive array includes at least one of a conductive carbon ink, a metal particle ink, copper plated trace, a metal oxides, a conductive polymer, a carbon nanotube, a silver dispersions, and a deposited copper.

5. The conductive panel according to claim 1, wherein the conductive array includes at least one of an X-trace layer having a plurality of first parallel conductive traces, a Y-trace layer having a plurality of second parallel conductive traces, and a discrete sensor pad.

6. The conductive panel according to claim 1, further comprising a dielectric material interposed between at least one of the substrate and the conductive array and the film layer and the conductive array to provide an insulator therebetween.

7. The conductive panel according to claim 5, wherein the dielectric material includes a barrier material to minimize a migration rate of oxygen and moisture through the conductive panel.

8. The conductive panel according to claim 1, further comprising a decorative layer disposed adjacent at least one of the substrate, the conductive array, and the film layer, wherein the decorative layer provides a pre-determined appearance to the conductive panel.

9. The conductive panel according to claim 1, further comprising at least one of a protective layer, a grounding layer, and an electroluminescent layer, wherein the protective layer is disposed on the film layer to provide a protective shielding of the panel, the grounding layer is in electrical communication with the conductive array for minimizing sensitivity to electrical noise, and the electroluminescent layer cooperates with the conductive array to provide a light emitting function.

10. A conductive panel system comprising:
a film layer formed to a pre-determined shape;
a conductive array having a plurality of electrical traces insulated from one another by a dielectric material, the conductive array disposed adjacent the film layer; and
a substrate disposed adjacent at least one of the film layer and the conductive array for supporting the conductive panel, wherein the substrate is formed to receive an electrical interconnection device for providing electrical communication between the conductive array and a secondary device.

11. The conductive panel system according to claim 10, wherein the film layer has a multiple axis, multiple dimension surface curvature.

12. The conductive panel system according to claim 10, wherein the conductive array includes at least one of an X-trace layer having a plurality of first parallel conductive traces, a Y-trace layer having a plurality of second parallel conductive traces, and a discrete sensor pad.

13. The conductive panel system according to claim 10, wherein the electrical interconnection device is at least one of a flex circuit and an electrical connector having a means for coupling the electrical interconnection device to the substrate of the panel and aligning an electrical lead of the electrical interconnection device with a suitable portion of the conductive array.

14. The conductive panel system according to claim 10 wherein an electrically conductive epoxy is applied between an electrical lead of the electrical interconnection device and a portion of the conductive array for providing electrical communication therebetween.

15. The conductive panel system according to claim 10, wherein the secondary device is at least one of a source of electrical energy, a means for measuring the capacitance of the electrical traces, and a means for processing the capacitance measurements.

16. The conductive panel system according to claim 10, further comprising a decorative layer disposed adjacent at least one of the substrate, the conductive array, and the film layer, wherein the decorative layer provides a pre-determined appearance of the conductive panel.

17. A method for forming a conductive panel, the method comprising the steps of:
forming a film layer into a desired shape;
depositing a conductive array on a surface of the film layer, wherein the conductive array includes a plurality of electrically conductive traces insulated from one another by a dielectric material; and
providing a substrate adjacent at least one of the film layer and the conductive array to provide rigid support for the film layer.

18. The method according to claim 17, wherein the film layer is formed into a shape having a multiple axis, multiple dimension surface curvature.

19. The method according to claim 17, wherein the film layer is formed into the desirable shape at least one of prior to the deposition of the conductive array and after the deposition of the conductive array.

20. The method according to claim 17, further comprising the step of adjusting a width and depth of the electrically conductive traces in response to at least one of a calibration calculation and a strain calculation.
